(19) United States
(12) Patent Application Publication
(10) Pub. No.: US 2003/0052948 A1
(43) Pub. Date: Mar. 20, 2003

(54) Inkjet printhead chip

(76) Inventors: Arnold Chang-Mou Yang, San Jose, CA (US); Chen-Hua Lin, Yunlin Hsien (TW); Ming-Hsun Yang, Taipei (TW); Wen-Chung Lu, Kaohsiung (TW); Ching-Yu Chou, Taipei (TW)

Correspondence Address: BIRCH STEWART KOLASCH & BIRCH, PO BOX 747, FALLS CHURCH, VA, 22040-0747, US

(21) Appl. No.: 10/213,153

(22) Filed: Aug. 7, 2002

(30) Foreign Application Priority Data
Sep. 14, 2001 (TW) 90122816

(51) Int. Cl. B41J 2/05

(52) U.S. Cl. 347/65

(57) ABSTRACT

An inkjet printhead chip is installed at the nose of an ink cartridge. Its structure includes a silicon substrate, a barrier layer, and a nozzle plate. The nozzle plate is formed with two parallel rows of inkjet nozzles. Two rows of ink channels roughly parallel to the inkjet nozzles and two rows of independent control circuits are provided among the silicon substrate, the barrier layer and the nozzle plate. The ink channels are disposed between the two rows of nozzles. The control circuits are configured to be on the outer sides of the two rows of nozzles. Using this structure of ink channels and control circuits, the inkjet printhead chip allows a larger area for attaching the nozzle plate. A flexible printed circuit is used to send external control signals from both sides of the chip to the control circuits, starting ink firing elements to eject ink and form patterns or texts on a nearby medium.

### BACKGROUND OF THE INVENTION

1. Field of Invention

The invention relates to an inkjet printhead chip and, in particular, to a chip structure which has ink channels distributed between two rows of nozzles on the chip and control circuits distributed on the outer sides of the nozzles.

2. Related Art

The commonly used inkjet chips nowadays are of two types; namely, the thermal ones and the piezoelectric ones. Due to severe competition among the same kind of products, researchers have to make further progress so that the new inkjet chip has a structure that satisfy all requirements. Furthermore, the manufacturing process has to be devised so that the cost lowers while the yield increases. All these reply on breakthroughs in the designs of structure, manufacturing process, and materials. Taking as an example the U.S. Pat. No. 4,683,481, “Thermal Ink Jet Common-Slotted Ink Feed Printhead”, a silicon substrate is drilled with a central reservoir for transporting ink to common channels inside each ink cavity on the silicon substrate. The silicon substrate is covered with a piece of metal nozzle plate. The nozzles on the nozzle plate are aligned with the ink cavities on the silicon substrate. When the heater resistor in any one of the ink cavities is supplied with an electrical current, the ink around the resistor is rapidly heated and vaporized instantaneously to eject out of the metal nozzle.

As the old machining technology is not as good as today, making a reservoir in the middle of the silicon substrate is a complicated and expensive process. The U.S. Pat. No. 5,635,966 with the title “Edge Feed Ink Delivery Thermal Inkjet Printhead Structure And Method Of Fabrication” thus proposed the following improved structure without drilling a central reservoir. The improved structure has the appearance shown in FIG. 1. The inkjet chip 30 at the nose 11 is enclosed under a flexible printed circuit 20, which is formed with extremely tiny nozzles 22 using special laser machining. Therefore, it has the function of a normal nozzle plate or orifice plate. As the nozzles 22 are formed on the flexible printed circuit 20 using laser, each nozzle 22 has to be precisely aligned with each ink firing chamber 33 in the inkjet chip 30 before the flexible printed circuit 20 is attached onto the inkjet chip 30; otherwise, it cannot accomplish desired inkjet function.

As shown in FIG. 2, one can see the cross-sectional structure of the nose 11 in this type of ink cartridge 10. A central slot 12 is formed inside the nose 11. At the end of the central slot 12 is fixed with a silicon substrate 31. The space between both edges 310 of the silicon substrate 31 and the nose 11 is used form separate ink channels 13 that are in fluid communications with the central slot 12. The ink flows from the central slot 12 through the silicon substrate edges 310 and enters an ink firing chamber 33. With an ink firing element 34, the ink on the flexible printed circuit 20 is ejected out of the nozzles 22 and forms ink droplets.

One can further understand the structure by looking at the three-dimensional exploded perspective shown in FIG. 3. The ink follows the big arrow 40 shown in the drawing to the edges 310 of the silicon substrate 31 and enters an ink firing chamber 33. The ink inside the ink firing chamber 33 is excited by the ink firing element 34 and ejects out of the nozzles 22 on the flexible printed circuit 20. The structure of the ink firing chamber 33 can be understood from FIG. 4. In FIG. 4, the dotted area represents the profile of a barrier layer 32. The barrier layer 32 is on the surface of the silicon substrate 31. After patternization and etching, several spacers are formed to form ink inlets 321, narrow openings 320, and the innermost ink firing chamber 33. Each ink firing chamber 33 is installed with an ink firing element 34. The ink firing element 34 can be a thermal resistor or piezoelectric element that reacts to signals entered through a pad 21 and interpreted by the control circuit 35. The ink cartridge 10 then follows the command to eject ink droplets out of the nozzles 22.

After all the nozzles 22 and the ink firing chambers 33 are aligned, the barrier layer 32 and the flexible printed circuit 20 are connected using a thin adhesive layer 23. At the same time, the rim is sealed with adhesive seal 24. Finally, all devices are covered under the flexible printed circuit 20. The finished product is shown in FIG. 5. Only those tiny nozzles 22 are exposed on the surface of the nose 11 of the ink cartridge 10.

After the above-mentioned structure was disclosed, many similar ideas were also proposed, for example, in the U.S. Pat. Nos. 5,638,101, 5,648,805, and 5,946,012. Aligning the tiny nozzles 22 on the flexible printed circuit 20 with the ink firing chambers 33 is extremely difficult. It involves the controls of environmental temperature and humidity. The connection between the flexible printed circuit 20 and the barrier layer 32 has to be very careful so that the adhesive seal is not applied too much to clog any of the nozzles 22 or the ink firing chambers 33. Therefore, the manufacturing process requires precision equipment. It will be an expensive investment if one wants to mass-produce such products.

To lower the technical difficulty and cost in making the product, the invention modifies and improves the structure of the inkjet printhead chip.

### SUMMARY OF THE INVENTION

An objective of the invention is to remove the technical problem of requiring a precision alignment between the flexible printed circuit 20 and the barrier layer 32 by making changes in the structure. The main modification is that the ink channels are moved from the outer sides to the inner sides of the nozzles, dividing the central control circuit into two that are move to the outer sides. A flexible printed circuit with a window is connected to the control circuit at the border of the chip. In this manner, there is enough area at the center of the chip for the nozzle plate to attach.

### BRIEF DESCRIPTION OF THE DRAWINGS

FIG. 1 shows the appearance of an ink cartridge in the prior art, where nozzles are formed on a flexible printed circuit using laser and cover the surface of an inkjet chip. The function of a normal nozzle plate can be achieved after connecting the flexible printed circuit with the inkjet chip.

FIG. 2 is a cross-sectional view of the nose of an ink cartridge in the prior art, where ink flows from a central slot through the edge of a silicon substrate into an ink firing chamber. The ink is excited by the ink firing element inside the ink firing chamber and ejected out of the nozzles on the flexible printed circuit, forming ink droplets.

FIG. 3 is a three-dimensional exploded view of an inkjet chip in the prior art, where ink follows the big arrow direction to flow through the edge of a silicon substrate into an ink firing chamber.

FIG. 4 is a schematic view showing the relation between the barrier layer of the inkjet chip and the nose of the ink cartridge in the prior art, where the dotted area represents the barrier layer profile.

FIG. 5 is a schematic view showing the relation between the inkjet chip and the flexible printed circuit in the prior art.

FIG. 6 is a schematic view showing the relation between the inkjet chip and the flexible printed circuit according to the invention.

FIG. 7 shows the appearance of the disclosed ink cartridge, where the flexible printed circuit does not cover the inkjet chip and, thus, no expensive precision equipment is needed for alignment and attachment during assembly.

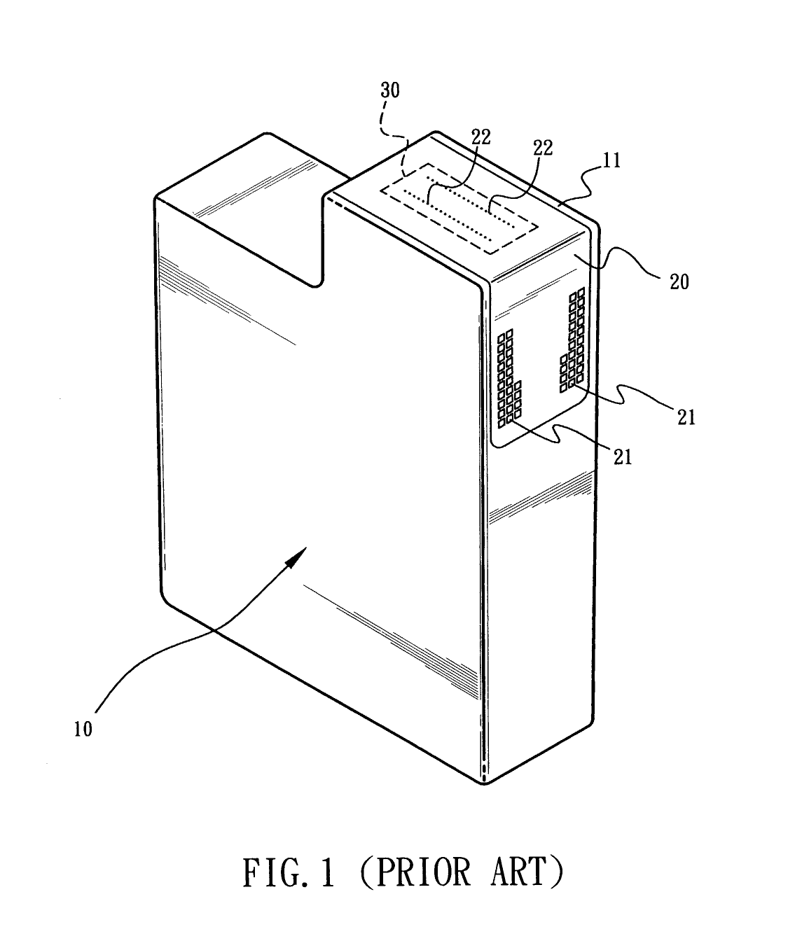

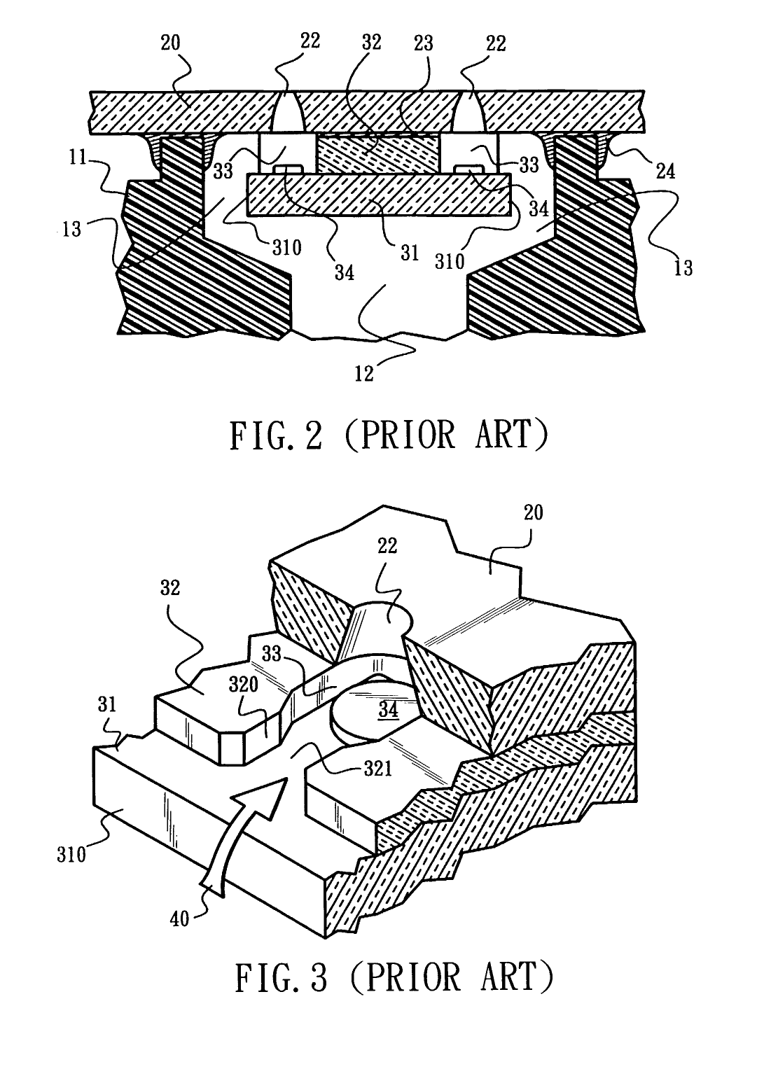

### DETAILED DESCRIPTION OF THE INVENTION

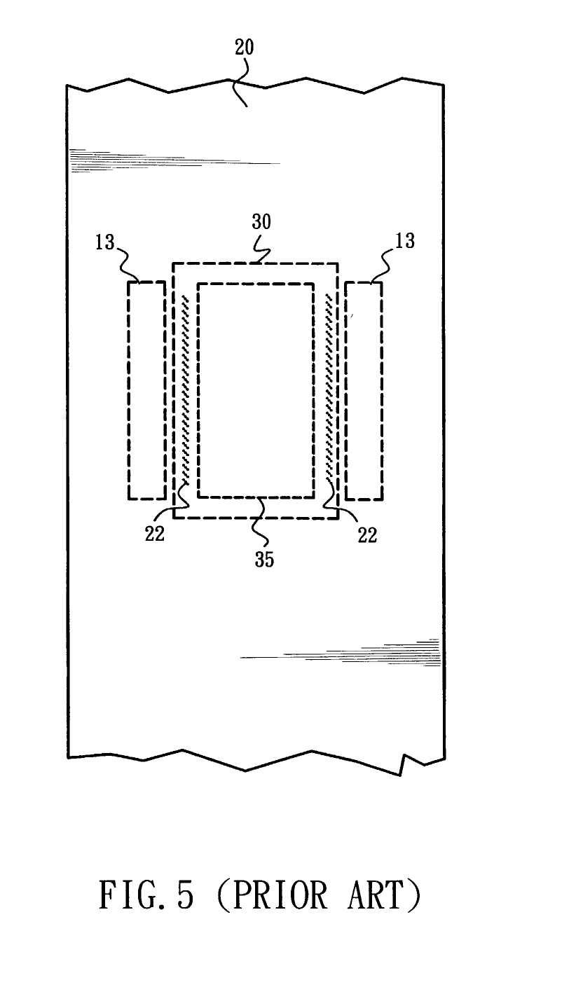

With reference to the known structure shown in FIG. 5, the inkjet chip 30 is installed with a control circuit 35 in the central portion. However, since the inkjet chip 30 does not have a nozzle plate, one needs to use a laser device to make rows of nozzles 22 on a flexible printed circuit 20. The flexible printed circuit 20 is then aligned and attached to the chip, forming a nozzle plate. In other words, if no flexible printed circuit 20 is attached or at least one of the nozzles 22 on the flexible printed circuit 20 is not properly aligned or clogged by the adhesive seal, then the finished ink cartridge will become useless. Since the machining of the inkjet chip 30 and the machining of the flexible printed circuit 20 are not continuous, therefore, expensive precision equipment and strict environment controls are needed to successfully make the desired products.

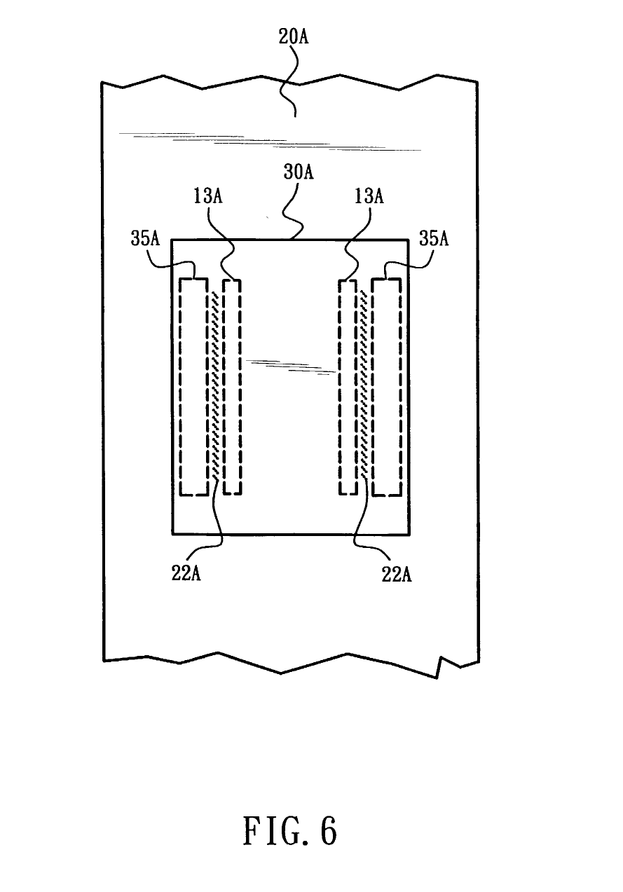

With reference to FIG. 6, the disclosed inkjet chip 30A has a pair of separate control circuits 35A that are in electrical communications with the flexible printed circuit 20A. Besides, the inkjet chip 30A has a nozzle plate. The flexible printed circuit 20A has a window so that the nozzle plate can expose its nozzles 22A. The manufacturing process and the material of the nozzle plate are not the essence of the invention. One can refer to various know manufacturing techniques. For example, the method disclosed in the U.S. Pat. No. 4,809,428 can directly use one manufacturing process to finish ink firing chambers with thermal resistors and a nickel nozzle plate. Alternatively, the technical content disclosed in the U.S. Pat. No. 5,376,856 also uses one manufacturing process to complete ink firing chambers with piezoelectric elements and a nozzle plate. Moreover, the nozzle plate can be made of polymers. For example, the U.S. Pat. No. 4,829,319 discloses a press molding method which can be used to produce nozzle plates made of polycarbonate or polyarcylate in the acryl family.

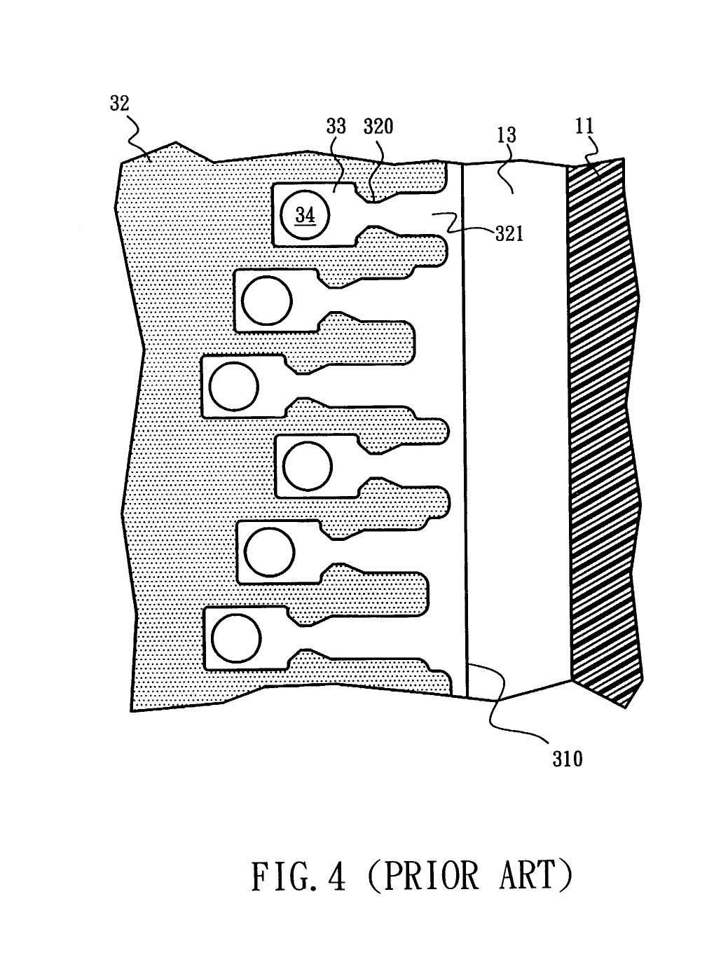

The disclosed inkjet chip 30A is comprised of at least one silicon substrate and a barrier layer, above which is attached with a nozzle plate. The barrier layer is first formed with a pattern by masking and then etched into a profile the same as or similar to the barrier layer 32 shown in FIG. 4 (the dotted area), forming several spacers and ink firing chambers. Each ink firing chamber is installed with a thermal element or a piezoelectric element to excite the ink inside the ink firing chamber so that the ink is ejected out of the nozzles on the nozzle plate.

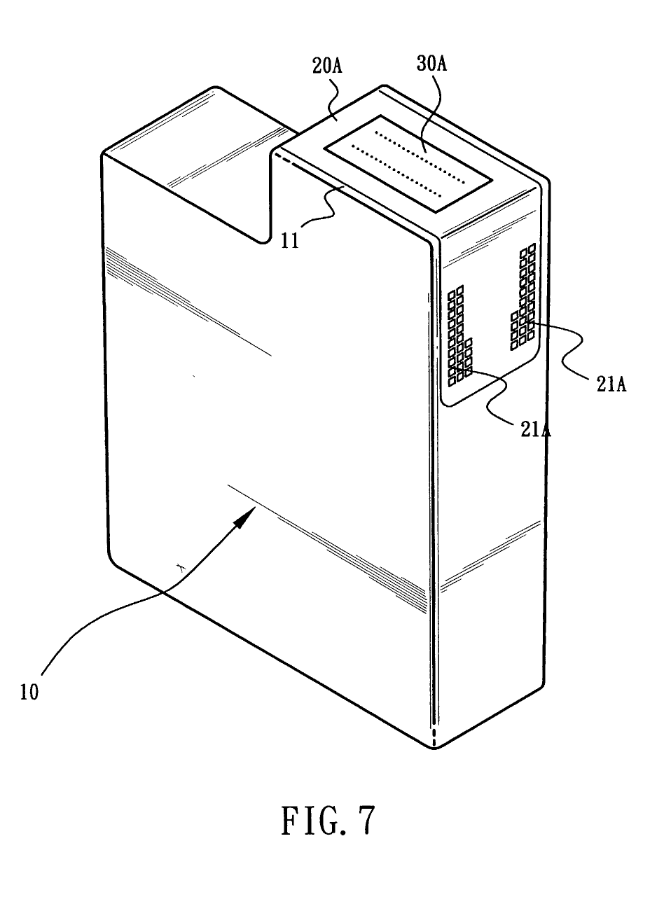

Comparing FIGS. 5 and 6, one sees that the differences between the invention and FIG. 5 are the following. (A) The invention has a window on the flexible printed circuit 20A so that the nozzle plate is exposed to the ambient space without being blocked by the flexible printed circuit 20A. (B) To increase the attaching area between the nozzle plate and the inkjet chip 30A, the control circuits 35A originally provided in the middle of the inkjet chip 30 is divided into two parts and moved to the outer sides of the nozzles 22A on the inkjet chip 30A. On the other hand, the ink channels 13A originally formed on the outer sides are moved to the inner sides of the nozzles 22A. The flexible printed circuit 20A and the control circuits 35A are in electrical communications. Another surface of the flexible printed circuit 20A is installed with signal-in pads 21A so that they are exposed on one side of the ink cartridge 10, receiving external control signals and transferring them to the control circuits 35A. The appearance of the finished product is shown in FIG. 7.

Certain variations would be apparent to those skilled in the art, which variations are considered within the spirit and scope of the claimed invention.

What is claimed is:

1. An inkjet printhead chip for installing a nose of an ink cartridge and in electrical communications with a flexible printed circuit, the chip comprising:
a silicon substrate provided with a plurality of ink firing elements on its surface;
a barrier layer formed atop the silicon substrate and having a plurality of ink firing chambers surrounding one of the ink firing elements;
a nozzle plate formed with two rows of parallel nozzles with distribution corresponding respectively to the plurality of ink firing elements for the ink inside the ink firing chambers to eject out;
a pair of control circuits disposed on outer sides of the two rows of nozzles and is in electrical communications with the flexible printed circuit for receiving external control signals to activate the ink firing elements; and
a pair of ink channels distributed on inner sides of the two rows of nozzles for supplying and replenishing ink to the ink firing chambers.

2. The inkjet printhead chip of claim 1, wherein the flexible printed circuit has a window to make the nozzles exposed on the surface of the nozzle plate.

3. The inkjet printhead chip of claim 1, wherein the flexible printed circuit has a plurality of signal-in pads for transferring external signals to the control circuits.

4. The inkjet printhead chip of claim 3, wherein the signal-in pads of the flexible printed circuit are exposed on one side of the ink cartridge.

5. The inkjet printhead chip of claim 1, wherein the ink firing element is a piezoelectric element.

6. The inkjet printhead chip of claim 1, wherein the ink firing element is a thermal element.

7. The inkjet printhead chip of claim 1, wherein the nozzle plate is made of a metal.

8. The inkjet printhead chip of claim 7, wherein the metal is selected from the group consisting of nickel (Ni) and its compounds.

9. The inkjet printhead chip of claim 1, wherein the nozzle plate is made of a polymer.

10. The inkjet printhead chip of claim 9, wherein the polymer is selected from the group consisting of polycarbonate and polyarcylate in the acryl family.
